(19) United States
(12) Patent Application Publication
(10) Pub. No.: US 2015/0153771 A1
(43) Pub. Date: Jun. 4, 2015

(54) TABLET PC EXTERNAL EQUIPMENT

(71) Applicants: Inventec (Pudong) Technology Corporation, Shanghai (CN); INVENTEC CORPORATION, TAIPEI CITY (TW)

(72) Inventor: Yun-Tang LIN, TAIPEI CITY (TW)

(73) Assignees: Inventec (Pudong) Technology Corporation, Shanghai (CN); INVENTEC CORPORATION, TAIPEI CITY (TW)

(21) Appl. No.: 14/250,382

(22) Filed: Apr. 10, 2014

(30) Foreign Application Priority Data
Nov. 29, 2013 (CN) 201310629981.1

(51) Int. Cl. G06F 1/16

(52) U.S. Cl. CPC G06F 1/1624

(57) ABSTRACT

A tablet PC external equipment includes a machine body and a slider. The machine body has a first convex portion, a trigger button, and a pair of ports. The first convex portion, the trigger button, and the ports are located on a side-top of the machine body. The trigger button is connected with the machine body by a resilient member. The trigger button has a stopper at the bottom thereof. The slider is connected with the machine body slidably. The slider has a flexible second convex portion, a pair of snaps, a strutting sheet, an operating button, a spring, a first notch, and a second notch.

### RELATED APPLICATIONS

This application claims priority to Chinese Application Serial Number 201310629981.1 filed Nov. 29, 2013, which is herein incorporated by reference.

### BACKGROUND

1. Technical Field

The present disclosure relates to a tablet PC external equipment.

2. Description of Related Art

Conventional external keyboard sets adapted for a tablet PC can be classified into two kinds, and one kind of external keyboard set is configured to support the tablet. PC and is connected with the tablet PC by Bluetooth technology or an electrical connecting port. However, this kind of external keyboard set does not include any locking device to fix the tablet PC. This kind of external keyboard set is easy to use and has a simple structure, but it cannot fix the tablet PC steadily. As a result, the tablet PC may be disengaged from the external keyboard set by an external force, and thus is easily dropped and damaged. Another kind of external keyboard set is configured to fix the tablet PC by latches or lockers, but this kind of external keyboard set must be assembled or disassembled by two hands. For example, while disassembling, a user must unlock the lockers with one hand and pull the tablet PC up with another hand, which is inconvenient for the user.

### SUMMARY

The disclosure provides a tablet PC external equipment including a machine body and a slider. The machine body has a first convex portion, a trigger button, and a pair of ports. The first convex portion, the trigger button, and the ports are located on a side-top of the machine body. The trigger button is connected with the machine body by a resilient member. The trigger button has a stopper at the bottom thereof. The slider connected with the machine body slidably. The slider has a flexible second convex portion, a pair of snaps, a strutting sheet, an operating button, a spring, a first notch, and a second notch. The snaps are located at two ends of the slider and are aligned with the ports respectively. Each of the ports and the corresponding snap are configured to plug into a connecting groove of the tablet PC. A spring is connected between the slider and the machine body. When the user needs to disengage the tablet PC from the machine body, the user can move the operating button to move the slider away from the first convex portion, and then the strutting sheet is moved away from the bottom of the trigger button and pops up to abut against the trigger button, so as to make the snaps disengage from the connecting groove. After the tablet PC is removed from the machine body, the trigger button is lifted up by the resilient member, so that the bottom of the trigger button is higher than the strutting sheet. Therefore, the strutting sheet does not abut against the trigger button, and thus moves the slider to the first convex portion by the spring until the stopper abuts against the first notch, and the strutting sheet is moved to the bottom of the trigger button. When the tablet PC is placed into the machine body, the trigger button is pressed by the tablet PC, and the stopper does not abut against the first notch, so that the slider is moved to the first convex portion by the spring until the second convex portion abuts against the first convex portion. When the second convex portion abuts against the first convex portion, the snaps protrude out of the ports and are engaged to the connecting grooves. When the user moves the operating button to make the second convex portion interfere with the first convex portion, the second convex portion is elastically deformed and moved to the trigger button, and the second convex portion is finally located between the trigger button and the first convex portion. Therefore, the snaps further protrude out of the ports, and the stopper abuts against the second notch to fix the slider.

In an embodiment of the present disclosure, four sides of the ports that are connected with the tablet PC are chamfered.

In an embodiment of the present disclosure, the resilient member is a compressible spring.

In an embodiment of the present disclosure, the strutting sheet and the second convex portion are formed from one piece metal.

In an embodiment of the present disclosure, the top of the operating button has a plurality of anti-slip grooves.

In an embodiment of the present disclosure, the machine body includes a keyboard.

In an embodiment of the present disclosure, the machine body includes an electrical connector configured to be electrically connected with the tablet PC.

In an embodiment of the present disclosure, the electrical connector is located between the ports.

In an embodiment of the present disclosure, each of the snaps is L-shaped, and each of the connecting grooves is L-shaped so as to be engaged to or disengaged from the snaps.

In an embodiment of the present disclosure, each of the ports has a snap groove configured to accommodate the corresponding snap. When the snaps are entirely placed into the snap grooves, the tablet PC is disengaged from the snaps.

Accordingly, the tablet PC external equipment of the present disclosure can firmly engage the machine body to the tablet PC steadily and can be operated with one hand. A user can easily engage the tablet PC to the machine body or disengage the tablet PC from the machine body. When the user needs to disengage the tablet PC from the machine body, the user can move the operating button so that the snaps is disengaged from the tablet PC, and then the tablet PC can be removed from the tablet PC external equipment. When the tablet PC is placed into the machine body, the snaps can be engaged to the tablet PC automatically. Finally, when the user moves the operating button to fix the slider, the tablet PC is firmly fixed to the machine body and is not disengaged from the machine body even if the tablet PC is pressed by an external force. When the user need to disengage the tablet PC from the machine body, the user can operate the operating button to move the slider away from the first convex portion, and then the tablet PC can be removed from the tablet PC external equipment.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a perspective view showing that a tablet PC is engaged to a tablet PC external equipment according to an embodiment of the present disclosure;

FIG. 2 is a rear view showing that the tablet PC external equipment is engaged to the tablet PC;

FIG. 3 is a perspective view of a slider and periphery units thereof according to an embodiment of the present disclosure;

FIG. 4 is a front view of the slider and the periphery units thereof in FIG. 3;

FIG. 5 is a perspective view of the tablet PC external equipment in a performing status according to an embodiment of the present disclosure;

FIG. 6 is a top view of the tablet PC external equipment in FIG. 5;

FIG. 7 is a side view of a strutting sheet and a trigger button in FIG. 6;

FIG. 8 is a perspective view of the tablet PC external equipment in another continuous performing status according to another embodiment of the present disclosure;

FIG. 9 is a perspective view of the tablet PC external equipment in the continuous performing status according to another embodiment of the present disclosure;

FIG. 10 is a side view of the strutting sheet and the trigger button in FIG. 8;

FIG. 11 is a perspective view of the tablet PC external equipment in another performing status according to another embodiment of the present disclosure;

FIG. 12 is a top view of the tablet PC external equipment in FIG. 11;

FIG. 13 is a perspective view of the tablet PC external equipment in another performing status according to another embodiment of the present disclosure;

FIG. 14 is a top view of the tablet PC external equipment in FIG. 13;

FIG. 15 is a perspective view of the tablet PC external equipment in another performing status according to another embodiment of the present disclosure; and

FIG. 16 is a top view of the tablet PC external equipment in FIG. 15.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

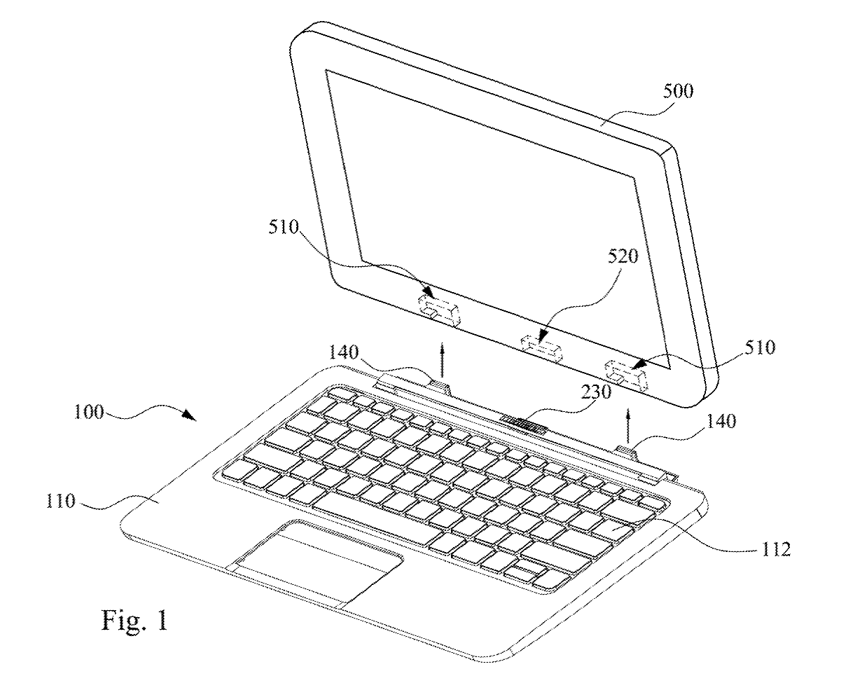

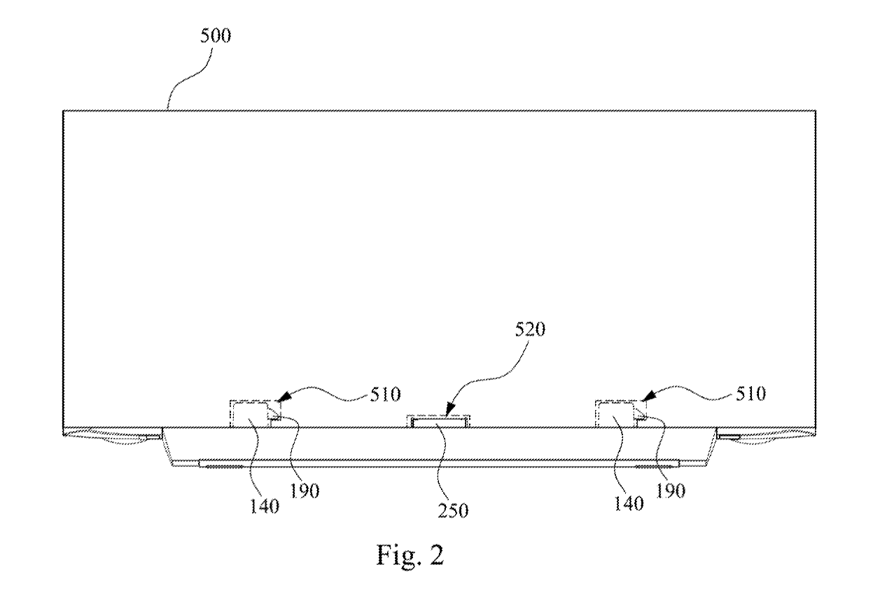

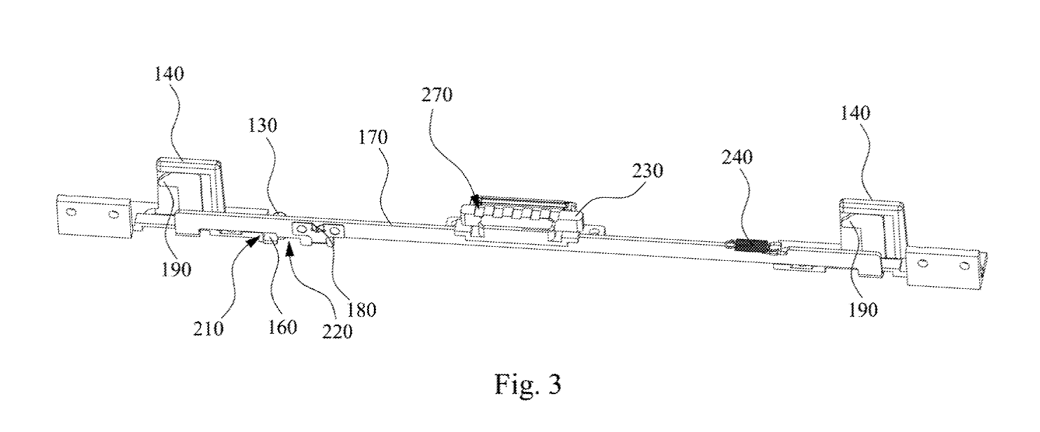

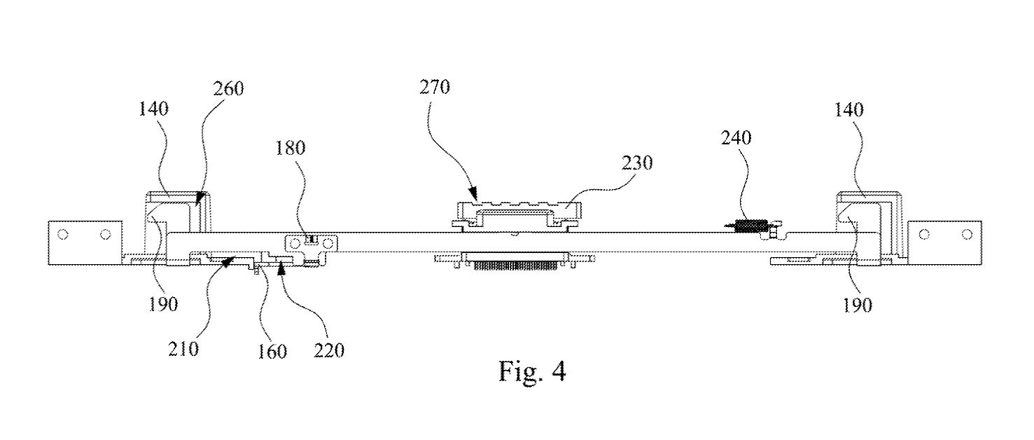

In order to solve a problem that a conventional tablet PC is too complicated to engaged or disengaged from an external the keyboard set, the presented disclosure provides a tablet PC external equipment to improve the problem. FIG. 1 is a perspective view showing that a tablet PC is engaged to a tablet PC external equipment according to an embodiment of the present disclosure. FIG. 2 is a rear view showing that the tablet PC external equipment is engaged to the tablet PC. The tablet PC external equipment 100 of the present disclosure includes a machine body 110 and a slider 170 (referring to FIG. 3). The slider 170 (referring to FIG. 3) is slidably connected with the machine body 110. When a user needs to engage the tablet PC 500 to the tablet PC external equipment 100, the tablet PC 500 needs to be engaged by ports 140 and snaps 190 of the machine body 110. The snaps 190 are located at two ends of the slider 170 (referring to FIG. 3) and are aligned with the ports 140 respectively. Each of the ports 140 and the corresponding snap 190 are configured to plug into a connecting groove 510 of the tablet PC 500. A spring 240 (referring to FIG. 4) is connected between the slider 170 and the machine body 110. According to another embodiment of the present disclosure, the spring 240 is an extension spring. According to an embodiment of the present disclosure, the machine body 110 includes a keyboard 112. According to another embodiment of the present disclosure, the machine body 110 includes an electrical connector 250, and the tablet PC 500 has an electrical connecting groove 520 configured to be electrically connected with the electrical connector 250. According to another embodiment of the present disclosure, each of the snaps 190 is L-shaped, and each of the connecting grooves 510 is L-shaped so as to engage to or disengage from the corresponding snap 190. According to another embodiment of the present disclosure, four sides of the ports 140 that are connected with the tablet PC 500 are chamfered, so that the tablet PC 500 can be smoothly placed into the ports 140.

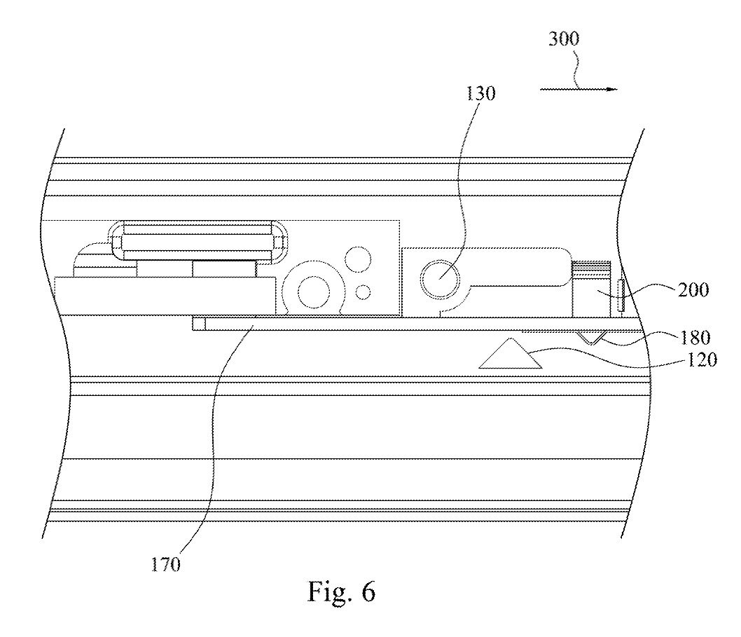

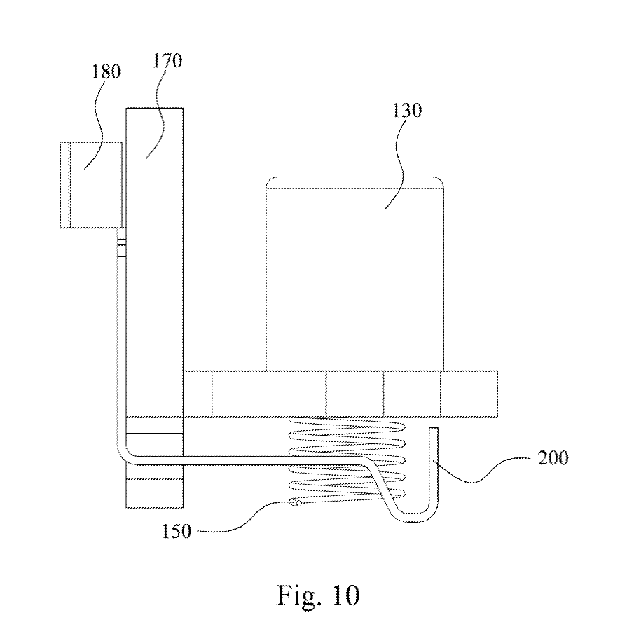

FIG. 3 is a perspective view of a slider and periphery units thereof according to an embodiment of the present disclosure. FIG. 4 is a front view of the slider and the periphery units thereof in FIG. 3. The tablet PC external equipment 100 (referring to FIG. 1) of the present disclosure includes a machine body 110 (referring to FIG. 1) and a slider 170. The machine body 110 (referring to FIG. 1) has a first convex portion 120 (referring to FIG. 6), a trigger button 130, and a pair of the ports 140. The first convex portion 120 (referring to FIG. 6), the trigger button 130, and the pair of the ports 140 are located on a side-top of the machine body 110. The trigger button 130 is connected with the machine body 110 (referring to FIG. 1) through a resilient member 150 (referring to FIG. 10). The trigger button 130 has a stopper 160 located on the bottom thereof. The slider 170 is slidably connected with the machine body 110 (referring to FIG. 1). The slider 170 has a flexible second convex portion 180, a pair of the snaps 190, a strutting sheet 200, an operating button 230, a spring 240, a first notch 210, and a second notch 220. According to another embodiment of the present disclosure, each of the ports 140 has a snap groove 260 configured to accommodate the corresponding snap 190. When the snaps 190 are entirely placed into the snap grooves 260, the tablet PC 500 (referring to FIG. 1) can be disengaged from the snaps 190 and the ports 140. According to another embodiment of the present disclosure, the electrical connector 250 is located between the ports 140. According to another embodiment of the present disclosure, the resilient member 150 is a compressible spring. According to another embodiment of the present disclosure, the top of the operating button 230 has a plurality of anti-slip grooves 270 configured to let the user operate without sliding.

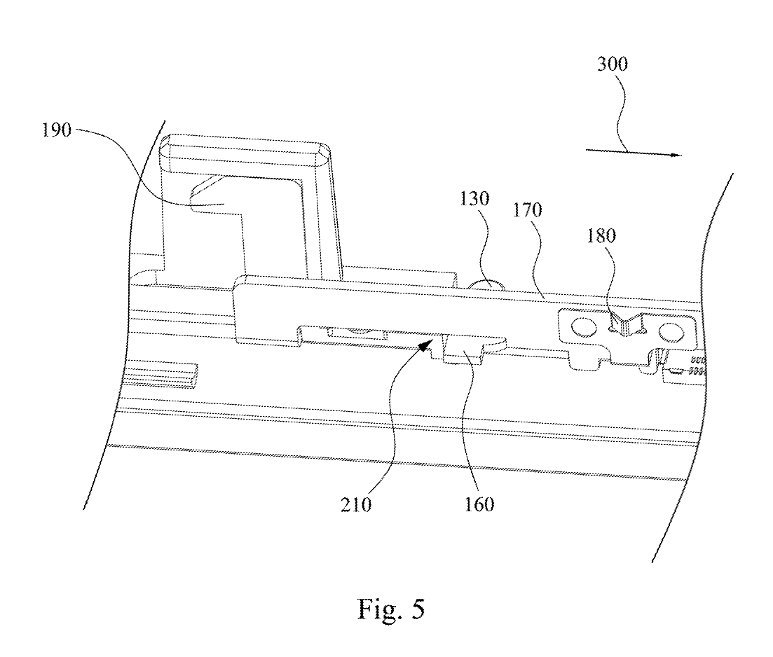

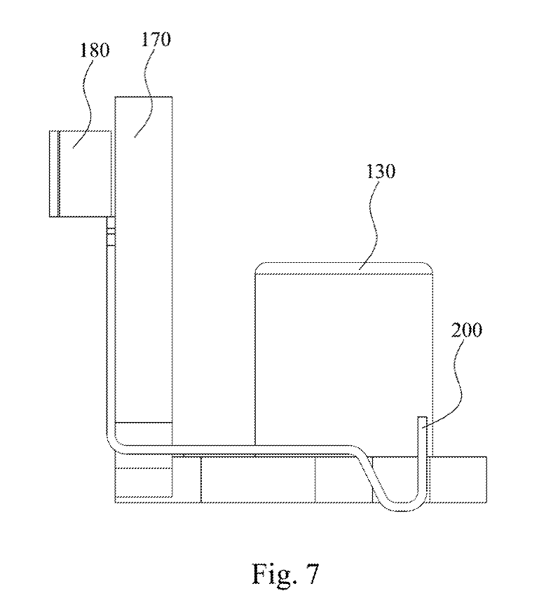

FIG. 5 is a perspective view of the tablet PC external equipment in a performing status according to an embodiment of the present disclosure. FIG. 6 is a top view of the tablet PC external equipment in FIG. 5. FIG. 7 is a side view of a strutting sheet and a trigger button in FIG. 6. When the user needs to disengage the tablet PC 500 (referring to FIG. 1) from the machine body 110, the user can move the operating button 230 (referring to FIG. 3) to move the slider 170 away from the first convex portion 120 (that is, to move along a direction 300), and then the strutting sheet 200 is moved away from the bottom of the trigger button 130 and pops up to abut against the trigger button 130, so as to make the snaps 190 disengage from the connecting groove 510 (referring to FIG. 2). In the meantime, the slider 170 is fixed by the strutting sheet 200, and the user can remove the tablet PC 500 (referring to FIG. 1) from the machine body 110. According to another embodiment of the present disclosure, the strutting sheet 200 and the second convex portion 180 are formed from a one piece metal.

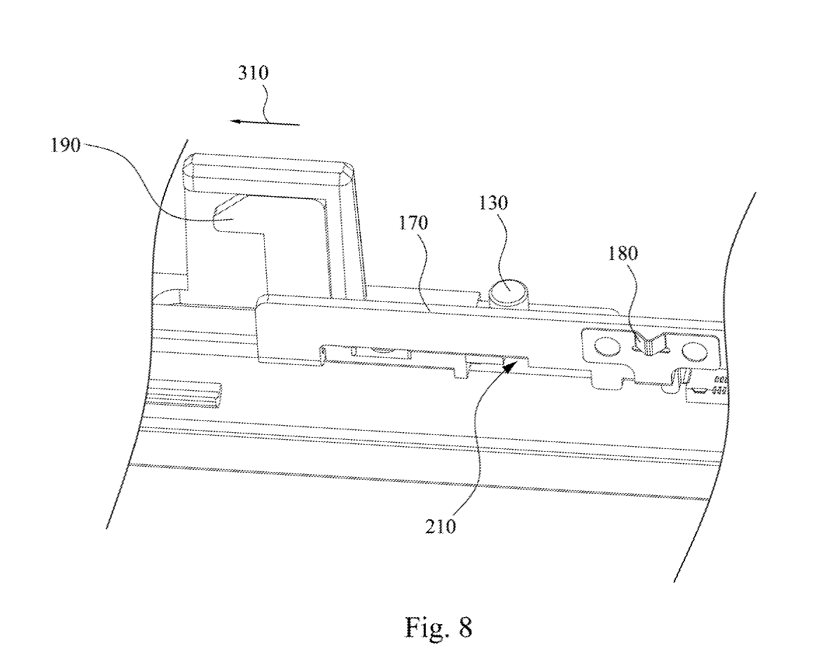

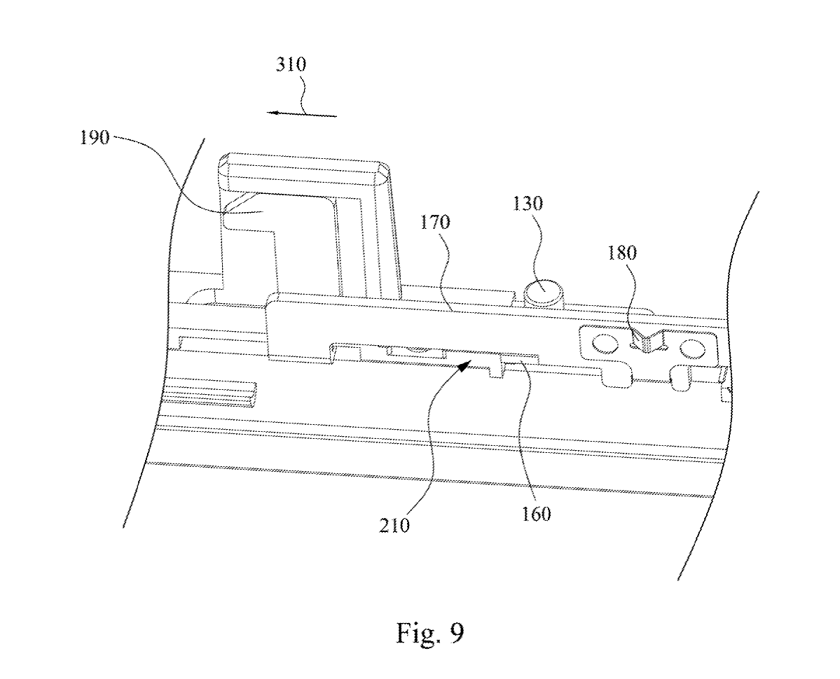

FIG. 8 is a perspective view of the tablet PC external equipment in another continuous performing status according to another embodiment of the present disclosure. FIG. 9 is a perspective view of the tablet PC external equipment in the continuous performing status according to another embodiment of the present disclosure. FIG. 10 is a side view of the strutting sheet and the trigger button in FIG. 8. After the tablet PC 500 (referring to FIG. 1) is removed from the machine body 110, the trigger button 130 is lifted up by the resilient member 150, so that the bottom of the trigger button 130 is higher than the strutting sheet 200. Therefore, the strutting sheet 200 does not abut against the trigger button 130, and thus moves the slider 170 to the first convex portion 120 (that is, moves along a direction 310) by the spring 240 (referring to FIG. 3) until the stopper 160 abuts against the first notch 210 (referring to FIG. 10), and the strutting sheet 200 is moved to the bottom of the trigger button 130.

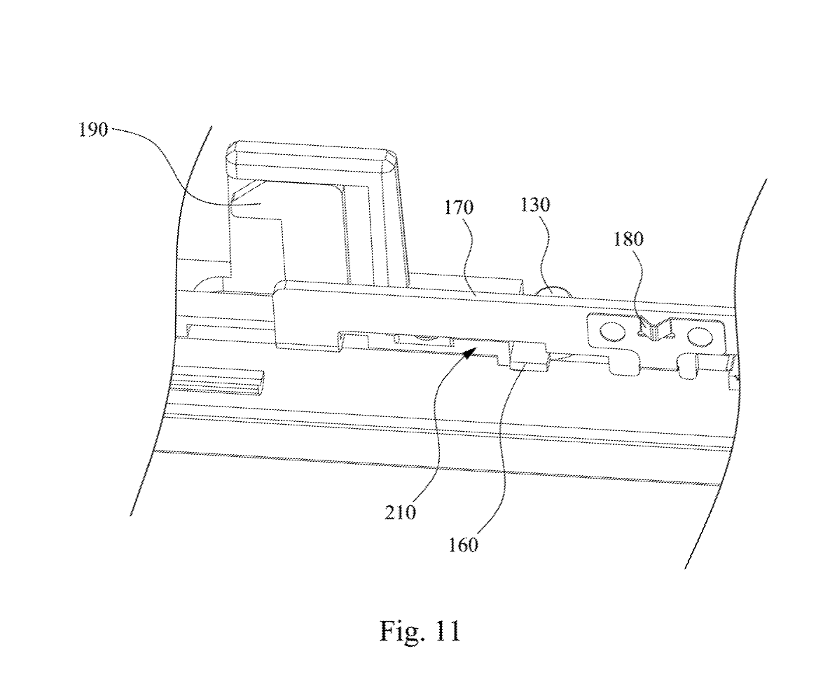

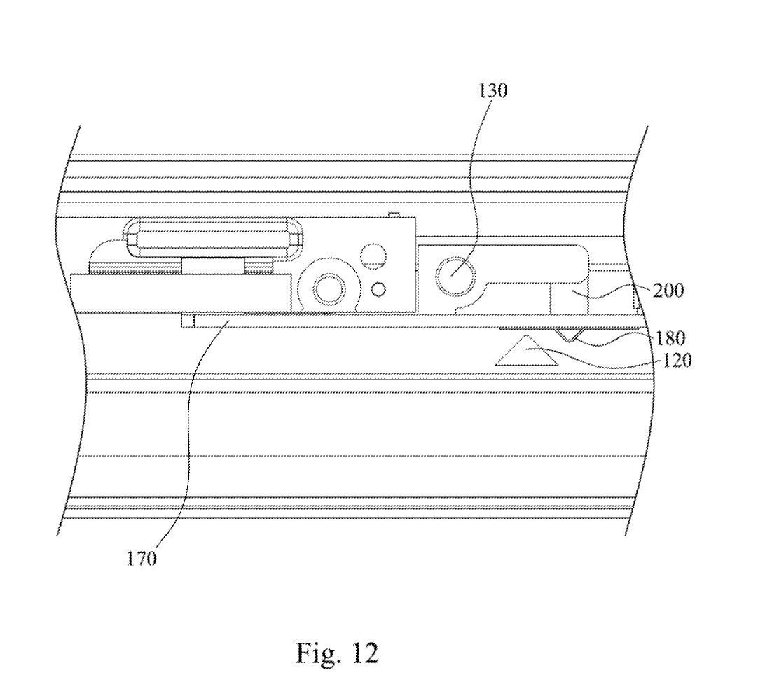

FIG. 11 is a perspective view of the tablet PC external equipment in another performing status according to another embodiment of the present disclosure. FIG. 12 is a top view of the tablet PC external equipment in FIG. 11. When the tablet PC 500 (referring to FIG. 1) is placed into the machine body 110, the trigger button 130 is pressed by the tablet PC 500, and the stopper 160 does not abut against the first notch 210, so that the slider 170 is moved to the first convex portion 120 by the spring 240 (referring to FIG. 3) until the second convex portion 180 abuts against the first convex portion 120.

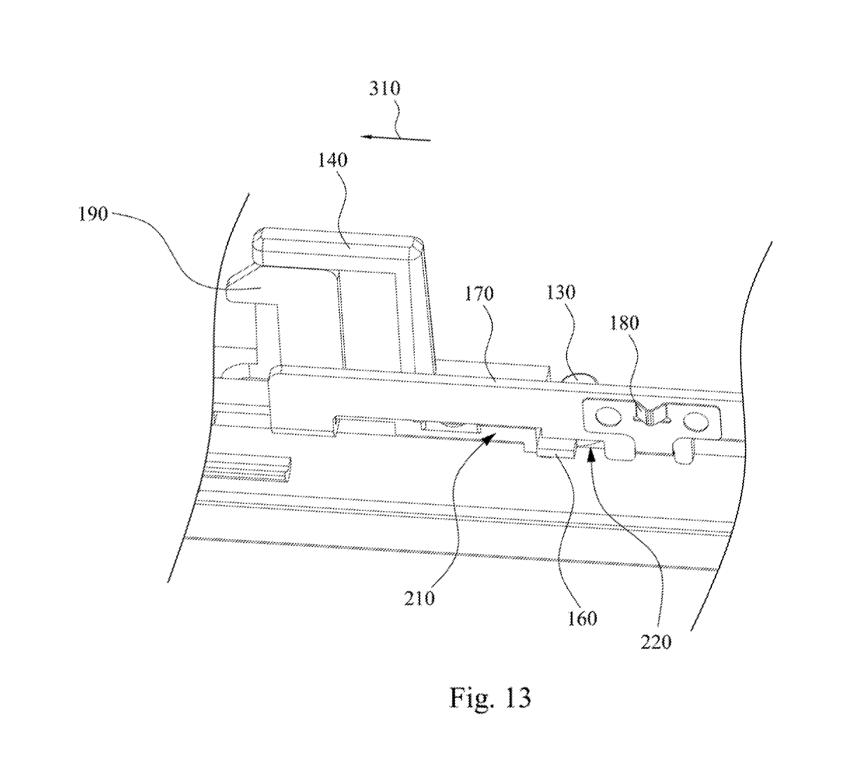

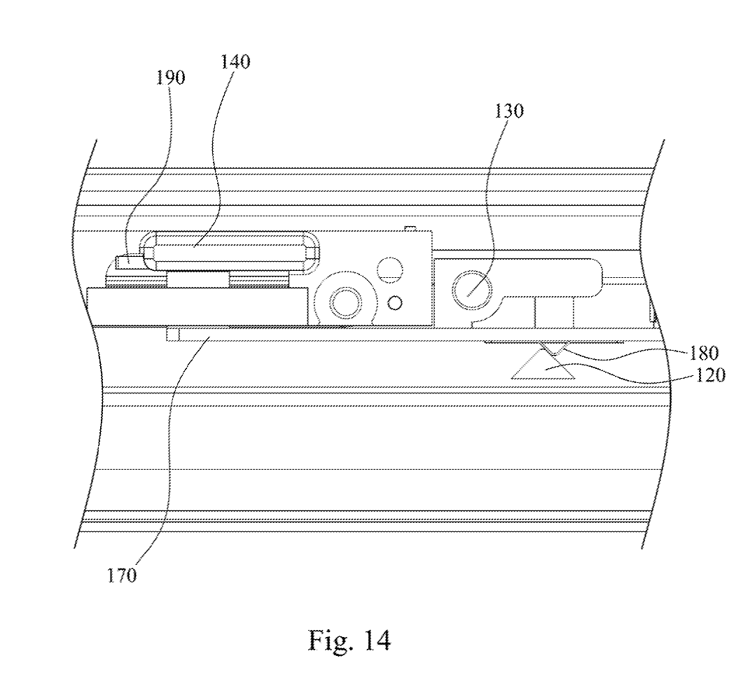

FIG. 13 is a perspective view of the tablet PC external equipment in another performing status according to another embodiment of the present disclosure. FIG. 14 is a top view of the tablet PC external equipment in FIG. 13. When the second convex portion 180 abuts against the first convex portion 120, the snaps 190 protrude out of the ports 140 along the direction 310 and are engaged to the connecting grooves 510 (referring to FIG. 2), so that the connecting grooves 510 are fixed to the machine body 110 (referring to FIG. 1). However, the snaps 190 may be disengaged from the slider 170 if the slider 170 is moved by an external force.

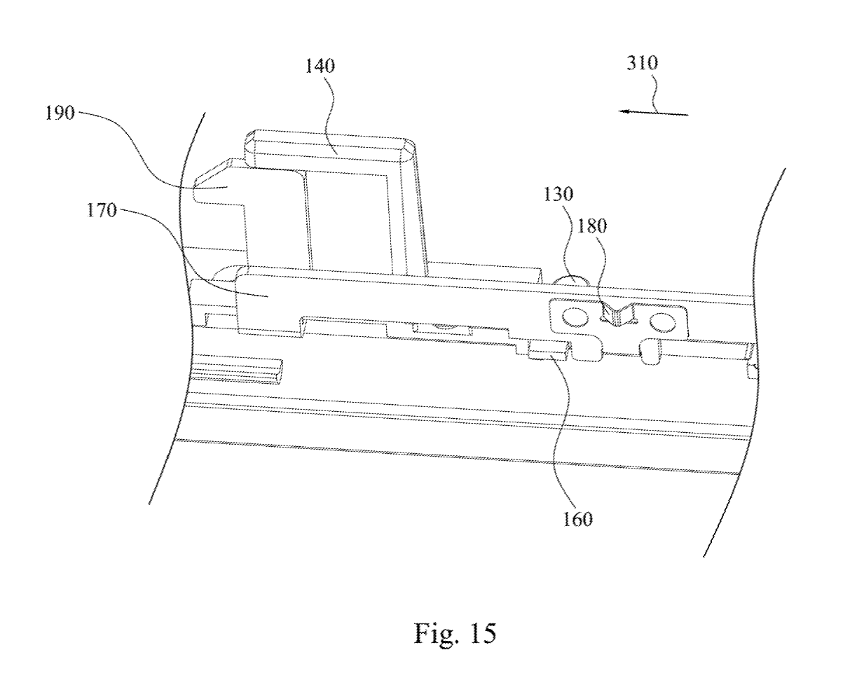

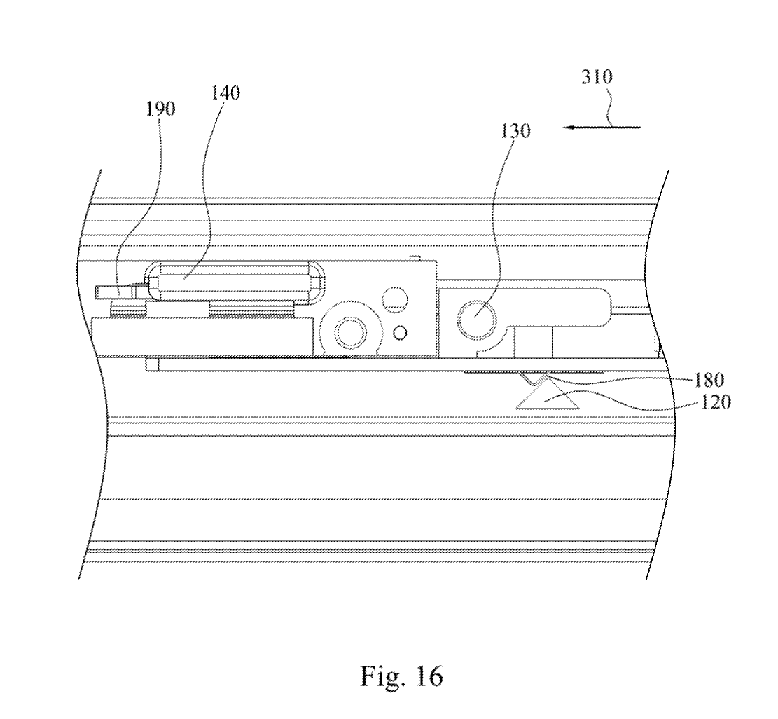

FIG. 15 is a perspective view of the tablet PC external equipment in another performing status according to another embodiment of the present disclosure. FIG. 16 is a top view of the tablet PC external equipment in FIG. 15. When the user moves the operating button 230 along the direction 310 to make the second convex portion 180 interfere with the first convex portion 120, the second convex portion 180 is elastically deformed and moved to the trigger button 130, and the second convex portion 180 is finally located between the trigger button 130 and the first convex portion 120. Therefore, the snaps 190 further protrude out of the ports 140 along the direction 310, and the stopper 160 abuts against the second notch 220 to fix the slider 170. In this status, even if the operating button 230 is forced by the external force, the slider 170 will not be moved, and the tablet PC 500 (referring to FIG. 1) will not be disengaged from the machine body 110 (referring to FIG. 1).

Accordingly, the tablet PC external equipment of the present disclosure can firmly engage the machine body to the tablet PC steadily and can be operated with one hand. The user can easily engage the tablet PC to the machine body or disengage the tablet PC from the machine body. When the user needs to disengage the tablet PC from the machine body, the user can move the operating button so that the snaps is disengaged from the tablet PC, and then the tablet PC can be removed from the tablet PC external equipment. When the tablet PC is placed into the machine body, the snaps can be engaged to the tablet PC automatically. Finally, when the user moves the operating button to fix the slider, the tablet PC is firmly fixed to the machine body and is not disengaged from the machine body even if the tablet PC is pressed by the external force. When the user need to disengage the tablet PC from the machine body, the user can operate the operating button to move the slider away from the first convex portion, and then the tablet PC can be removed from the tablet PC external equipment.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A tablet PC external equipment, comprising:
a machine body having a first convex portion, a trigger button, and a pair of ports, the first convex portion, the trigger button, and the ports being located on a side-top of the machine body, the trigger button being connected with the machine body by a resilient member, the trigger button having a stopper at the bottom thereof; and
a slider connected with the machine body slidably, the slider having a flexible second convex portion, a pair of snaps, a strutting sheet, an operating button, a spring, a first notch, and a second notch;
wherein the snaps are located at two ends of the slider and are aligned with the ports respectively, each of the snaps and the corresponding port are configured to plug in a connecting groove of a tablet PC, and the spring is connected between the slider and the machine body.

2. The tablet PC external equipment of claim 1, wherein four sides of the ports that are connected with the tablet PC are chamfered.

3. The tablet PC external equipment of claim 1, wherein the resilient member is a compressible spring.

4. The tablet PC external equipment of claim 1, wherein the strutting sheet and the second convex portion are formed from one piece metal.

5. The tablet PC external equipment of claim 1, wherein the top of the operating button has a plurality of anti-slip grooves.

6. The tablet PC external equipment of claim 1, wherein the machine body comprises a keyboard.

7. The tablet PC external equipment of claim 1, wherein the machine body comprises an electrical connector configured to be electrically connected with the tablet PC.

8. The tablet PC external equipment of claim 7, wherein the electrical connector is located between the ports.

9. The tablet PC external equipment of claim 1, wherein each of the snaps is L-shaped, and each of the connecting grooves is L-shaped so as to be engaged to or disengaged from the snaps.

10. The tablet PC external equipment of claim 1, wherein each of the ports has a snap groove configured to accommodate the corresponding snap, and when the snaps are entirely placed into the snap grooves, the tablet PC is disengaged from the snaps.
